(19) United States
(12) Patent Application Publication
(10) Pub. No.: US 2006/0115239 A1
(43) Pub. Date: Jun. 1, 2006

(54) Recording and reproducing apparatus

(76) Inventors: Hiroaki Shimazaki, Osaka (JP); Katsuo Saigo, Kobe-shi (JP); Hideyuki Ohgose, Osaka (JP); Kenjiro Tsuda, Osaka (JP)

Correspondence Address: MCDERMOTT WILL & EMERY LLP, 600 13TH STREET, N.W., WASHINGTON, DC, 20005-3096, US

(21) Appl. No.: 11/274,326

(22) Filed: Nov. 16, 2005

(30) Foreign Application Priority Data
Nov. 30, 2004 (JP) 2004-347540

(51) Int. Cl. H04N 7/52

(52) U.S. Cl. 386/95

(57) ABSTRACT

The present invention provides a recording and reproducing apparatus by which a user can specify to which recording medium a portion of content is transferred, even when the portion of the content is transferred from a source recording medium to another recording medium. A recording and reproducing apparatus includes a destination information generator which generates destination information for specifying a destination to which a transfer portion of content is transferred, and a move processor which transfers the transfer part to a second recording medium, and records the destination information onto the first recording medium by associating the destination information with a remaining content made up of remaining portions in a first recording medium.

### BACKGROUND OF THE INVENTION

(1) Field of the Invention

The present invention relates to a recording and reproducing apparatus which records and reproduces content such as audio and video, in particular to a recording and reproducing apparatus which notifies a user of a destination to which an irreproducible part of content due to a partial transfer of copyright-protected content has been transferred.

(2) Description of the Related Art

In recent years, high-quality audio/video contents (hereafter simply referred to as contents) which bear comparison with the original can be provided to each home by digital television broadcasting including high-quality, high-definition television broadcasting (hereafter referred to as HDTV). Furthermore, a digital video recorder which receives the contents broadcasted by the digital television broadcasting and records the received contents onto a hard disc, a rewritable optical disc and the like has been commercialized.

Accordingly, significance of protecting copyrights of video contents has been increasing and a mechanism called copy-once control has been introduced in terrestrial digital broadcasting since 2004.

Specifically, in the copy-once control, a control signal of “recordable only once” is added to the audio/video data and the audio/video data with added control signal is encrypted. Further, the encrypted digital data is broadcasted. Then, the received broadcast is allowed to be recorded in digital format only once when the broadcast is received. That is, the audio/video data to which the copy-once control signal is added can be recorded onto a recording medium such as a rewritable optical disc. However, whereas the copy-once control signal is rewritten to a copy prohibited control signal at the time of recording, it is prohibited to copy the recorded signal onto another recording medium. As an exception, it is allowed to transfer the recorded signal to another recording medium after deleting or making the signal irreproducible from the first recorded recording medium (e.g. refer to ARIB TR-B14, “Terrestrial digital television broadcasting standard operating procedure technical material” 8^{th} edition, Terrestrial digital television broadcasting content protection standard operating procedure).

However, in the conventional technology, in the case where a part of content is transferred to another recording medium, the reproduction is suddenly stopped when reproducing the rest of the content. Thus, consideration is not given to users. Furthermore, when the user wants to continuously reproduce the transferred part while reproducing the first part of the content, it is difficult to distinguish the recording medium to which the transferred part is transferred.

In particular, in the case where a part of the content is transferred to another recording medium and the rest of the content is further transferred to other recording medium, if the user who reproduced the rest of the content secondly transferred wants to reproduce the part firstly transferred, it is difficult to search the recording medium to which the first part is transferred.

### SUMMARY OF THE INVENTION

An object of the present invention is to provide a recording and reproducing apparatus by which, even when a part of the content is transferred to another recording medium, a user can specify the recording medium to which the part of the content is transferred.

In order to achieve the aforementioned object, a recording and reproducing apparatus according to the present invention comprises: a destination information generator configured to generate destination information specifying a transfer destination for a part of recorded content; and a processor configured to associate the transfer destination with a remaining part of the recorded content that was not transferred to the transfer destination.

Accordingly, in the case of reproducing the remaining content recorded on the original recording medium, the recording medium of the destination can be specified by verifying the destination information.

It should be noted that the present invention is not only realized as a recording and reproducing apparatus, but it may be realized such as a method for controlling the recording and reproducing apparatus (hereafter referred to as a recording and reproducing control method), a recording and reproducing control program for causing a computer system and the like to execute the recording and reproducing control method, a recording medium on which the recording and reproducing control program is recorded, and a system LSI to be embedded in the recording and reproducing apparatus.

Further, it may be realized as a recording medium on which the content generated by the recording and reproducing apparatus is recorded.

Furthermore, it may be realized as a system LSI in which a function for protecting copyright-protected content is embedded (hereafter referred to as content protection function), an IP core which forms the content protection function in a programmable logic device such as FPGA, CPLD and the like (hereafter referred to as a content protection core), and as a recording medium on which the content protection core is recorded.

Thus, the recording and reproducing apparatus according to the present invention, in the case where a copyright-protected content or a part of the content is transferred from a first recording medium to a second recording medium, inserts the destination information into a head part or a transfer part of a content (hereafter referred to as a remaining content) recorded in the first recording medium, the content being made up of a part remained in the first recording medium (hereafter referred to as remaining part) and a part transferred to the second recording medium and rewritten to an irreproducible state (hereafter referred to as transfer part). It then reproduces the remaining content including the portion into which the destination information is inserted.

Consequently, a recording medium of the destination can be also specified for the details of the transfer part by verifying the destination information when a user continuously reproduces the transfer part.

In particular, in the case where a part of content is transferred to another recording medium and the remaining part of the content is further transferred to other recording medium, a recording medium to which the part transferred firstly is transferred can be specified by verifying the content transferred secondly, that is the destination information inserted into the content transferred secondly when the user who reproduces the remaining content wants to reproduce the part transferred firstly.

It should be noted that a destination information generation unit 73a in the first recording and reproducing unit 52a may include a metadata generator 83a, a GUI screen generatior 84a, and an encoder 85a.

Also, it should be noted that the metadata generated by the metadata generator 83a may be inserted into content management information (hereafter referred to as metadata for program management).

As further information about technical background to this application, the disclosure of Japanese Patent Application No. 2004-347540 filed on Nov. 30, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a drawing showing a scheme of a recording and reproducing apparatus in a present embodiment;

FIG. 2 is a diagram showing a structure of hardware of the recording and reproducing apparatus in the embodiment;

FIG. 3 is a diagram showing a functional structure of the recording and reproducing apparatus in the embodiment;

FIG. 4A is a diagram showing a detailed functional structure of the recording and reproducing apparatus in the embodiment;

FIG. 4B is a diagram showing a detailed functional structure of the recording and reproducing apparatus in the embodiment;

FIG. 4C is a diagram showing a structure of the recording and reproducing apparatus in the embodiment;

FIG. 5 is a drawing showing a data structure of content before and after move processing is executed in the recording and reproducing apparatus in the embodiment;

FIG. 6 is a drawing showing an example of a destination setting image displayed on a display when the move processing is executed in the recording and reproducing apparatus in the embodiment;

FIG. 7 is a flowchart showing the move processing executed in the recording and reproducing apparatus in the present embodiment;

FIG. 8 is a flowchart showing transfer destination information generation processing executed in a transfer destination information generator in the present embodiment;

FIGS. 9A and 9B are drawings showing a data structure of content before and after the move processing is executed in the recording and reproducing apparatus in the present embodiment;

FIGS. 10A and 10B are diagrams showing a schematic structure of a reproduction apparatus in other embodiments;

FIG. 11 is a drawing showing a scheme of a desk-top recording and reproducing apparatus and a portable recording and reproducing apparatus in other embodiments; and

FIG. 12 is a drawing showing a scheme of the recording and reproducing apparatus and a printer in other embodiments.

### DESCRIPTION OF THE PREFERRED EMBODIMENT

### Embodiment

Hereafter, it is explained about an embodiment of the present invention with references to drawings.

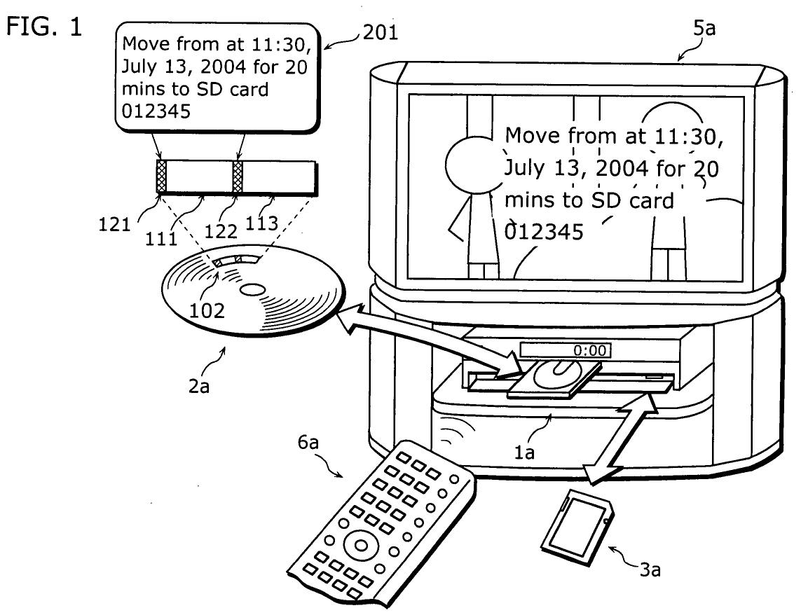

As shown in FIG. 1, a recording and reproducing apparatus la in the embodiment of the present invention is an apparatus which records and reproduces audio/video content (hereafter simply referred to as content) broadcasted by satellite digital broadcasting, terrestrial digital broadcasting and the like. Further, it has a function that the copyright-protected content can be transferred but cannot be copied (hereafter, the function is referred to as content protection function).

Furthermore, when a part of the copyright-protected content is transferred from a first recording medium 2a to a second recording medium 3a, information according to the destination (hereafter referred to as destination information) is inserted into, in the content recorded in the first recording medium 2a, a head part and a transfer part of the content 102 (hereafter referred to as remaining content) that is made up of parts 111 and 113 of the content remaining in the first recording medium 2a (hereafter referred to as a remaining part) and a part of the content transferred to the second recording medium 3a and rewritten to an irreproducible state (hereafter referred to as a transfer part), and recorded onto the first recording medium. Then, at the time when the user reproduces the remaining content 102, if the parts 121 and 122 to which the transfer destination information is inserted (hereafter referred to as insertion portion) are reproduced, the transfer destination is notified a user through a display 5a.

Based on the above mentioned characteristic, it is explained about the recording and reproducing apparatus la according to the embodiment.

First, it is exampled about a hardware structure of the recording and reproducing apparatus la according to the embodiment.

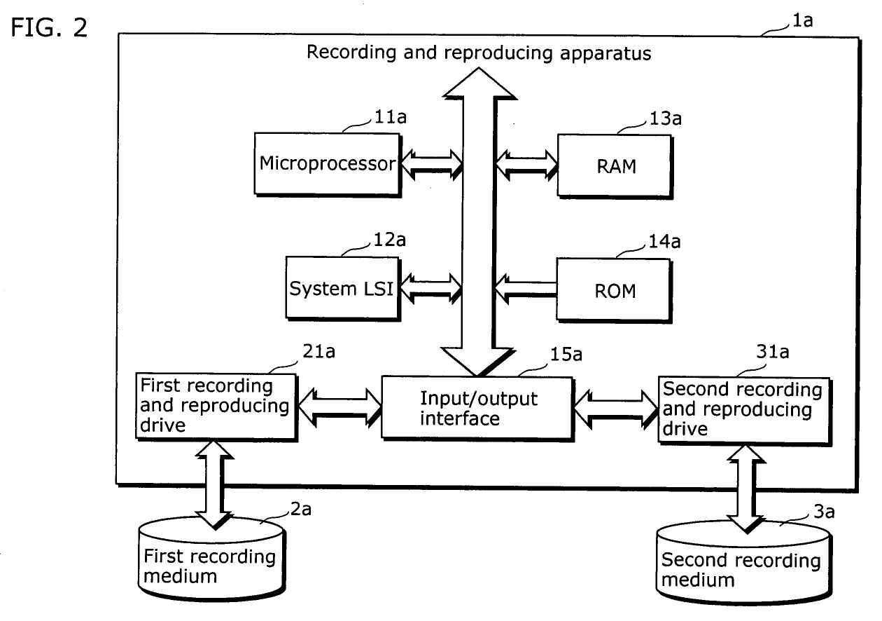

As shown in FIG. 2, the recording and reproducing apparatus 1a includes a microprocessor 11a, a system Large Scale Integration (LSI) 12a, a Random Access Memory (RAM) 13a, a Read Only Memory (ROM) 14a, and input/output interface 15a.

The microprocessor 11a is a central arithmetic processor which executes various processes necessary for executing recording and reproducing processing.

The system LSI 12a is an integrated circuit which executes image processing necessary for executing the recording and reproducing processing. For example, it is a codec which encodes and decodes an image based on picture coding methods such as Moving Picture Experts Group (MPEG), Joint Photographic Experts Group (JPEG) and H. 264.

The RAM 13a is a semiconductor memory from and to which data can be read and write whenever necessary. For example, it is a Dynamic Random Access Memory (DRAM) and a Static Random Access Memory (SRAM) and the like.

The ROM 14a is a memory for reading. For example, it is an Electronically Erasable and Programmable Read Only Memory (EEPROM) in which details can be electronically rewritten.

Whereas it is not shown in the diagram, the input/output interface 15a is an input/output interface which inputs and outputs data to internal devices and external devices that are connected to the recording and reproducing apparatus 1a. For example, it applies to the followings: a) an audio/video input/output interface such as analog video input/output, analog audio input/output, digital video input/output and digital audio input/output; b) a short-distance wireless transmission interface such as Bluetooth, Infrared Data Association (IrDA), and infrared radiation communication port; c) a serial transmission interface such as Universal Serial Bus (USB), Institute of Electrical and Electronics Engineers (IEEE) 1394, and a serial AT Attachment (ATA); d) a parallel transmission interface such as AT attachment Packet Interface (ATAPI); and e) a network interface such as IEEE802.3 and IEEE802.11.

Further, the recording and reproducing apparatus 1a includes a first recording and reproducing drive 21a and a second recording and reproducing drive 31a that are connected to an input/output interface 15a.

The first recording and reproducing drive 21a is a rewritable device for the first recording medium 2a.

The second recording and reproducing drive 31a is a rewritable device for the second recording medium 3a.

As the first recording medium 2a and the second recording medium 3a, there are Blu-ray Disk Rewritable (BD-RE), Hard Disk Drive (HDD), DVD-RAM, and SD (Secure Digital) memory card.

Whereas it is not shown in the diagram, it should be noted that the ROM 14a holds the following: an built-in Operating System (OS) for controlling the recording and reproducing apparatus 1a; a device driver necessary for the OS to control periphery devices; a middleware which operates on the OS; application software such as an user interface; and the like (hereafter referred to as recording and reproducing apparatus control program). The recording and reproducing apparatus control program is then read out from the ROM 14a when the electric current is applied to the recording and reproducing apparatus 1a, is stored in the RAM 13a and realizes each function according to the present invention in the recording and reproducing apparatus 1a.

Next, it is explained about a functional structure of the recording and reproducing apparatus 1a according to the present invention.

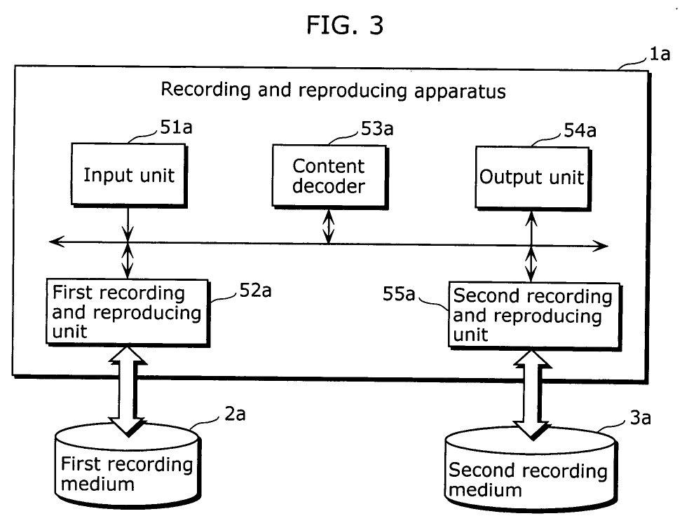

As shown in FIG. 3, the recording and reproducing apparatus 1a includes an input unit 51a, a first recording and reproducing unit 52a, a content decoder 53a, an output unit 54a, and a second recording and reproducing unit 55a.

Whereas it is not shown in the diagram, the input unit 51a demodulates the digital television broadcast signal selected by a tuner, and outputs the demodulated digital television broadcast signal as content to the first recording and reproducing unit 52a. Further, it receives operational information according to an instruction and setting from a user via a remote controller and the like, and outputs the received operational information to the first recording and reproducing unit 52a.

When recording the content outputted from the input unit 51a, the first recording and reproducing unit 52a performs necessary processing on the content outputted from the input unit 51a, and writes the processed content onto the first recording medium 2a. For example, the first recording and reproducing unit 52a rewrites, for the copyright-protected content, a control signal of copy-once included in the content to a control signal that is prohibited to be copied.

Further, when reproducing the content recorded on the first recording medium 2a, the recording and reproducing unit 52a reads out the content to be reproduced from the first recording medium 2a, and outputs the read content to the content decoder 53a.

The content decoder 53a decodes the content outputted from the first recording and reproducing unit 52a into an audio/video signal, and outputs the decoded audio/video signal to the output unit 54a.

Whereas not shown in the diagram, the output unit 54a outputs the audio/video signal outputted from the content decoder 53a to external devices such as a display and a speaker.

Further, when transferring the copyright-protected content from the first recording medium 2a to the second recording medium 3a, the first recording and reproducing unit 52a reads out the copyright-protected content from the first recording medium 2a, and outputs the read content to the second recording and reproducing unit 55a.

The second recording and reproducing unit 55a performs necessary processing on the content outputted from the first recording and reproducing unit 52a, and writes the processed content onto the second recording medium 3a.

Following that, it is explained about detailed functional structure of the recording and reproducing apparatus 1a in the embodiment. Here, the first recording and reproducing unit 52a is mainly described.

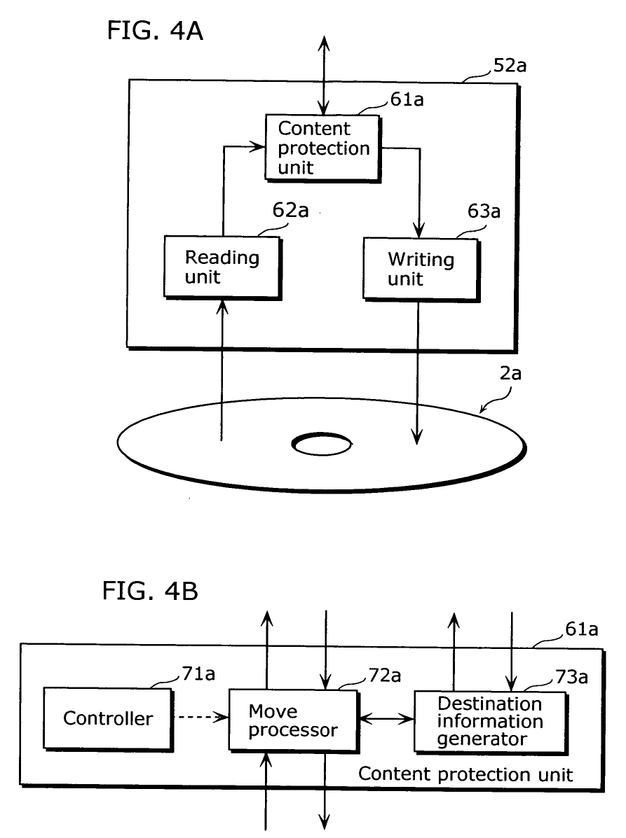

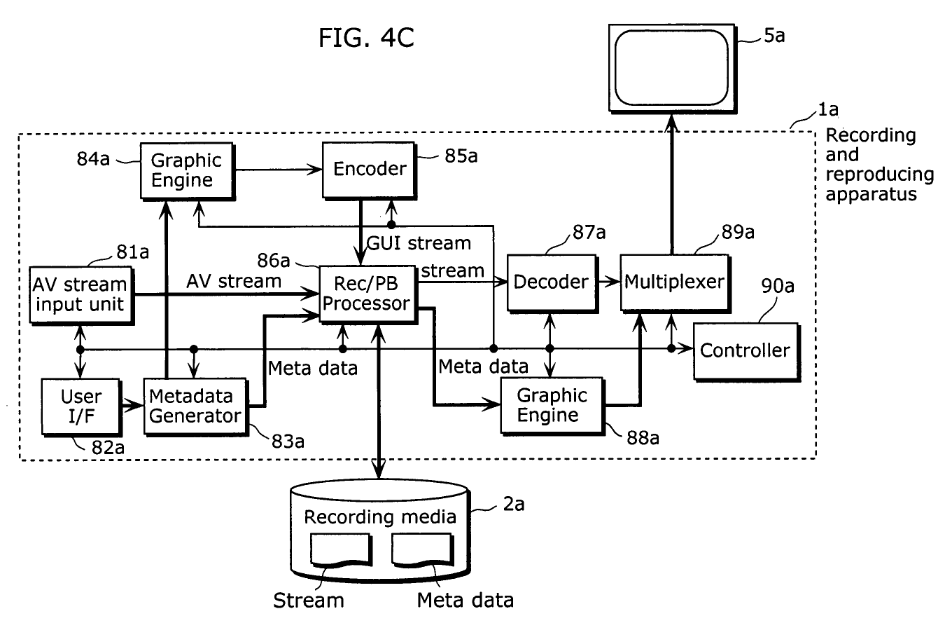

As shown in FIG. 4A, the first recording and reproducing unit 52a includes a content protection unit 61a, a reading unit 62a and a writing unit 63a.

The content protection unit 61a has a content protection function. It therefore protects copyrights of the content to be recorded onto the first recording medium 2a and contents that have been recorded.

The reading unit 62a reads out the content specified to be read out from the first recording medium 2a.

The writing unit 63a writes the content specified to be written onto the first recording medium 2a.

As shown in FIG. 4B, the content protection unit 61a further includes a controller 71a, a move processor 72a, and a destination information generator 73a.

When transferring the content or a part of the content according to the operational information outputted from the input unit 51a, that is, the user's operation, the controller 71a controls the move processor 72a so as to make it perform move processing, and to transfer the content or the part of the content.

The move processor 72a, before transferring the content to be transferred or a part of the content (hereafter referred to as data to be moved), makes the destination information generator 73a generate destination information. Also, it reads out the data to be moved from the first recording medium 2a, and outputs the read data to be moved to the second recording and reproducing unit 55a. It further rewrites the data to be moved recorded on the first recording medium 2a to irreproducible data.

The destination information generator 73a displays the destination setting picture on a display 5a and the like via the output unit 54a, and receives information according to the destination via the destination setting picture (hereafter referred to as destination information). It then generates a destination notification picture which notifies the destination to which the data to be moved is transferred according to the reproduction of the data, based on the destination information received via the input unit 51a. It then passes the generated destination notification picture to the move processor 72a.

The moving processor 72a receives the destination notification picture passed from the destination information generator 73a, codes the received destination notification picture into a stream, and inserts the coded stream into a head part of the original content and a part in which the data to be moved has been recorded.

It should be noted that the destination information generator 73a may generate information for specifying a recording medium of a destination (hereafter referred to as medium specification information) when generating a destination notification picture, using one of the following methods (1) to (3).

(1) The destination information generator 73a receives medium specification information from a user through a destination setting picture. It should be noted that the medium specification information that is received once is added to a choice of options so as to be selected out of the options from the next time.

(2) It obtains, as medium specification information, information unique to a recording medium that is a recording medium of a destination specified by a user via the destination setting picture.

(3) It randomly assigns a short identification number to each recording medium. The assigned identification number is considered as medium specification information.

The destination information generator 73a may generate audio information for notifying a destination instead of the destination notification picture.

It should be noted that the second recording and reproducing unit 55a may have the same structure as the first recording and reproducing unit 52a or may have a structure same as the first recording and reproducing unit 52a except omitting the content protection unit 61a from the constituents.

Further, the whole structure is explained in detail. As shown in FIG. 4C, the recording and reproducing apparatus 1a includes an AV stream input unit 81a, a user interface 82a, a metadata generator 83a, a graphic engine 84a, an encoder 85a, a recording and reproducing processor 86a, a decoder 87a, a graphic engine 88a, a multiplexer 89a, and a controller 90a.

The AV stream input unit 81a demodulates a digital television broadcast signal selected by a tuner, and outputs the demodulated digital television broadcast signal to a recording and reproducing processor 86a as a stream (AV). Note that, this is a function of the input unit 51a.

The user interface 82a receives an instruction and various information concerning a setting from a user via a remote controller and the like, and outputs the received various information to the metadata generator 83a. Note that, this is a function of the input unit 51a.

The metadata generator 83a generates metadata based on the various information inputted from the user interface 82a, and outputs the generated metadata to the graphic engine 84a and the recording and reproducing processor 86a. Herein, in the case where the information relating to a transfer destination is inputted, the metadata generator 83a generates metadata relating to the transfer destination. Note that, this is a function of the first recording and reproducing unit 52a.

The graphic engine 84a generates a graphical user interface (GUI) screen based on the metadata inputted from the metadata generator 83a, and outputs the generated GUI screen to the encoder 85a. Herein, in the case where the metadata relating to a recording medium of the transfer destination is inputted, the graphic engine 84a generates and outputs the GUI screen relating to the recording medium of the transfer destination. Note that, this is a function of the first recording and reproducing unit 52a.

The encoder 85a generates a stream (GUI) based on the GUI screen inputted from the graphic engine 84a, and outputs the generated stream (GUI) to the recoding and reproducing processor 86a. Note that, this is a function of the first recording and reproducing unit 52a.

The recording and reproducing processor 86a writes the stream (AV) inputted from the AV stream input unit 81a onto the first recording medium 2a. Also, it writes the metadata inputted from the metadata generator 83a onto the first recording medium 2a. Further, it writes the stream (GUI) inputted from the encoder 85a onto the first recording medium 2a. Herein, the metadata, the stream (AV) and the stream (GUI) are recorded by being associated with the first recording medium 2a each other. In the case of the stream (GUI) relating to the recording medium of the transfer destination, the stream (GUI) is inserted into a head portion of the stream (AV) remaining in the first recording medium 2a and into a portion where the data to be moved is existed. Further, at the time of reproduction, the recording and reproducing processor 86a respectively outputs the metadata and the stream to the graphic engine 88a and the decoder 87a. Note that, this is a function of the first recording and reproducing unit 52a.

The decoder 87a decodes the stream inputted from the recording and reproducing processor 86a into an audio/video signal, and outputs the decoded audio/video signal to the multiplexer 89a. Note that, this is a function of the content decoder 53a.

The graphic engine 88a generates a GUI screen based on the metadata inputted from the recording and reproducing processor 86a, and outputs the generated GUI screen to the multiplexer 89a. Herein, in the case where the metadata relating to the transfer destination is inputted, the graphic engine 88a generates and outputs the GUI screen relating to the transfer destination. Note that, this is a function of the output unit 54a.

The controller 90a reads the information relating to the recording medium of the transfer destination, for example a disc name, and outputs the read information to the graphic engine 84a, when it performs move processing. Or, the controller 90a urges a user to input the information relating to the recording medium of the transfer destination via the user interface 82a. It then outputs the information relating to the recording medium of the transfer destination to the graphic engine 84a. Herein, the character string itself may be inputted or default information as a choice, for example, it may be selected from a general information such as “external media 1”, information stored in a pre-obtained nonvolatile memory and the like. Note that, this is a function realized by respective functions of the input unit 51a, the first recording and reproducing unit 52a, the content decoder 53a, the output unit 54a, and the second recording and reproducing unit 55a.

Next, it is explained about a data structure of the content before and after the move processing is executed by the recording and reproducing apparatus in the embodiment.

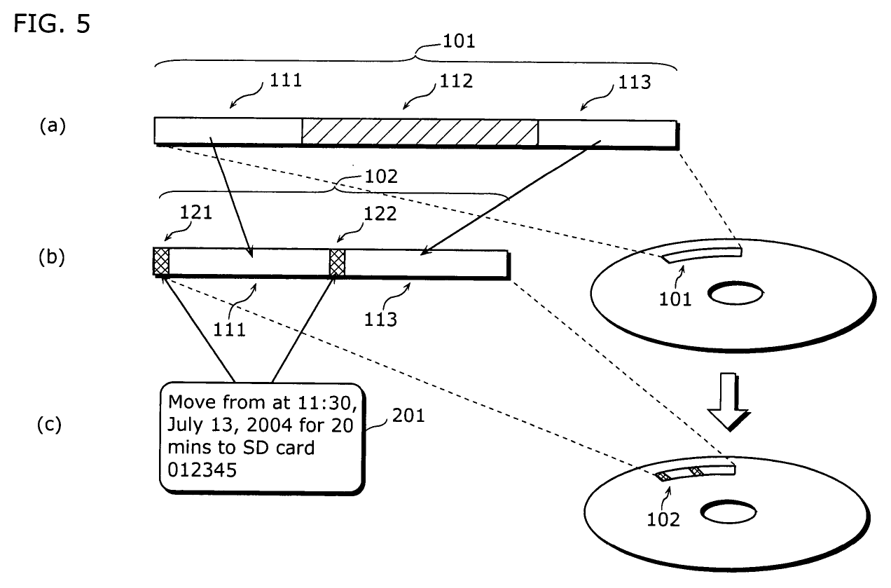

As shown in FIG. 5, before the move processing is executed, the content 101 is recorded on the first recording medium 2a. When the move processing is executed, a transfer part 112 of the content 101 is transferred to the second recording medium 3a. After the move processing is executed, the remaining content 102 is then recorded onto the first recording medium 2a.

Here, the remaining content 102 is made up of remaining parts 111 and 113, and insertion portions 121 and 122.

The remaining parts 111 and 113 are parts of the content 101 removing the transfer part 112 and are parts remained without being transferred even after the move processing is executed.

The insertion portions 121 and 122 are portions into which the destination information generated along with a transfer of the transfer part 112 are inserted, and in which the destination notification picture 201 is reproduced along with the reproduction of the remaining content 102.

Note that, the destination notification picture is coded so as to be reproduced seamlessly for the remaining parts 111 and 113.

Following that, it is explained about a destination setting picture displayed on a display when the move processing is executed in the recording and reproducing apparatus in the embodiment.

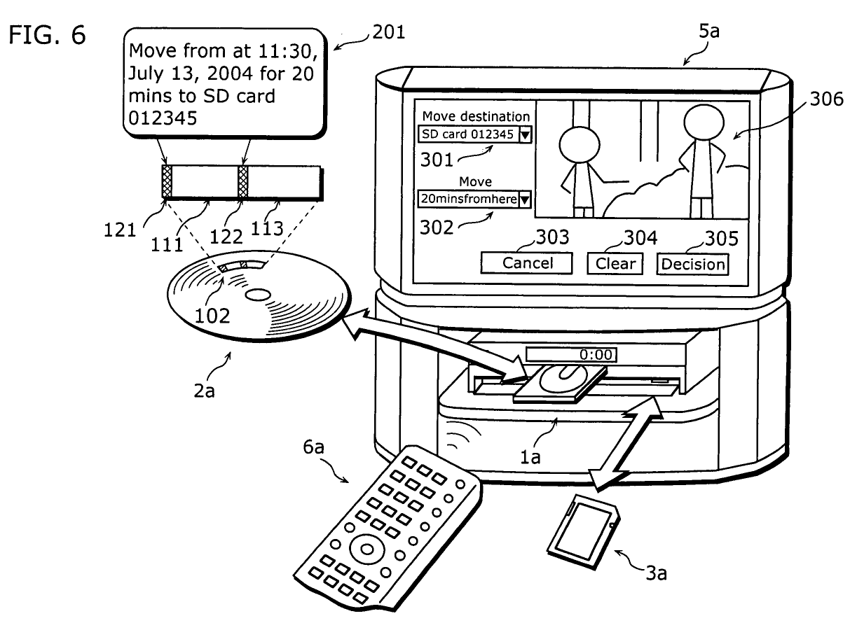

As shown in FIG. 6, the recording and reproducing apparatus 1a constructs a destination setting picture when it receives a move request from a user via a remote controller 6a. It then outputs the constructed destination setting picture to the display 5a via the output unit 54a.

For example, the destination setting picture displayed on the display 5a is made up of a move destination option 301, an option to be moved 302, a cancel button 303, a clear button 304, a decision button 305, and a move start picture display frame 306.

The move destination option 301 is a choice of options that is set to a recording medium of a destination when it is once selected and set.

The option to be moved 302 is a choice of options that is set as data to be moved when it is once selected and set.

The cancel button 303 is a button for canceling the set details when it is selected.

The clear button 304 is a button for clearing the set details when it is selected.

The decision button 305 is a button for determining the set details as destination information when it is selected.

The move start picture display frame 306 is a frame in which the move start picture is displayed.

The user, by operating the remote controller 6a, then selects and sets “SD card 012345” in the move destination option 301, and selects and sets “twenty minutes from here” in the option to be moved 302, and “at 11:30 on Jul. 13, 2004” is determined with the decision button 305. The recording and reproducing apparatus 1a then forms the destination notification picture 201 and codes the formed transfer destination notification picture 201 into a stream. The coded stream is recorded onto an insertion portion 121 of the remaining content 103 and onto an insertion portion 122 between the remaining part 111 and the remaining part 113.

Following that, it is explained about move processing executed by the recording and reproducing apparatus according to the embodiment.

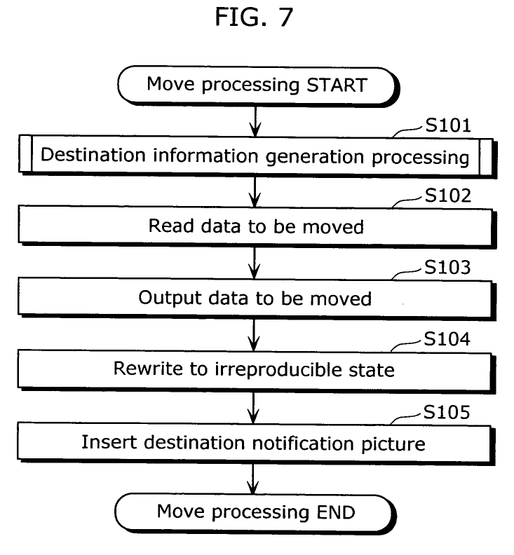

As shown in FIG. 7, the move processor 72a outputs a request to generate destination information to the destination information generator 73a before transferring the data to be moved.

In response, the destination information generator 73a executes destination information generation processing (step S101), and passes the destination notification picture obtained as the result of the process execution to the move processor 72a.

The move processor 72a further reads out data to be moved from the first recording medium 2a (step S102), and outputs the writing request for the read data to be moved to the second recording and reproducing unit 55a (step S103).

In response, the second recording and reproducing unit 55a receives the writing request outputted from the move processor 72a, and writes the data to be moved received together with the writing request onto the second recording medium 3a.

The move processor 72a rewrites the data to be moved recorded onto the first recording medium 2a to irreproducible data (step S104). It then receives the destination notification picture passed from the destination information generator 73a, codes the received destination notification picture into a stream (step S105), and inserts the coded stream in a head part and transfer part of the remaining content (step S106).

Next, it is explained about destination information generation processing executed in the destination information generator according to the embodiment.

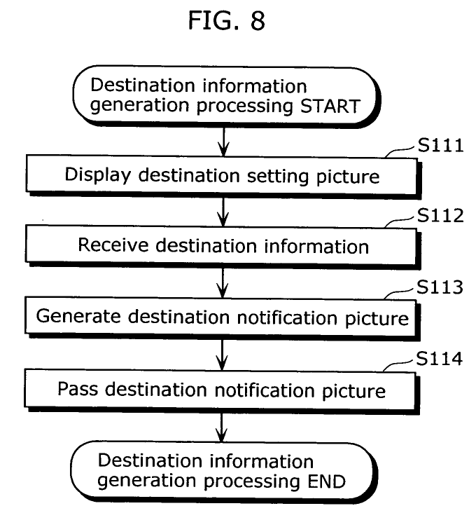

As shown in FIG. 8, the destination information generator 73a displays the destination setting picture on the display 5a and the like via the output unit 54a (step S111), and receives the destination information via the destination setting picture (step S112). It then generates a destination notification picture for notifying the destination of the data to be moved along with the reproduction of the data, based on the destination information received via the input unit 51a (step S113). Finally, it passes the generated destination notification picture to the move processor 72a (step S114).

As described in the above, the recording and reproducing apparatus according to the present invention, when the copyright-protected content or a part of the content is transferred from the first recording medium to the second recording medium, the destination notification picture is inserted into a head part and moving part of the remaining content, that is made up of the portion remaining in the first recording medium and a moving portion of the content transferred to the second recording medium and rewritten to irreproducible state, of the content recorded in the first recording medium. In the case of reproducing the remaining content, the remaining content is reproduced including the portions into which the destination notification picture is inserted.

Accordingly, when the user continuously reproduces the details of the parts transferred, the recording medium of the destination can be identified by verifying the destination notification picture.

In particular, in the case where a part of the content is transferred to a recording medium and the remaining part of the content is further transferred to another recording medium, when a user who reproduces the content transferred secondly, that is, the remaining content, wants to reproduce the content transferred firstly, it can be identified that to which one of recording medium the part firstly transferred is transferred by verifying the destination notification picture inserted to the content transferred secondly.

### Variations

It should be noted that the destination information may be inserted to metadata for program management instead of the content.

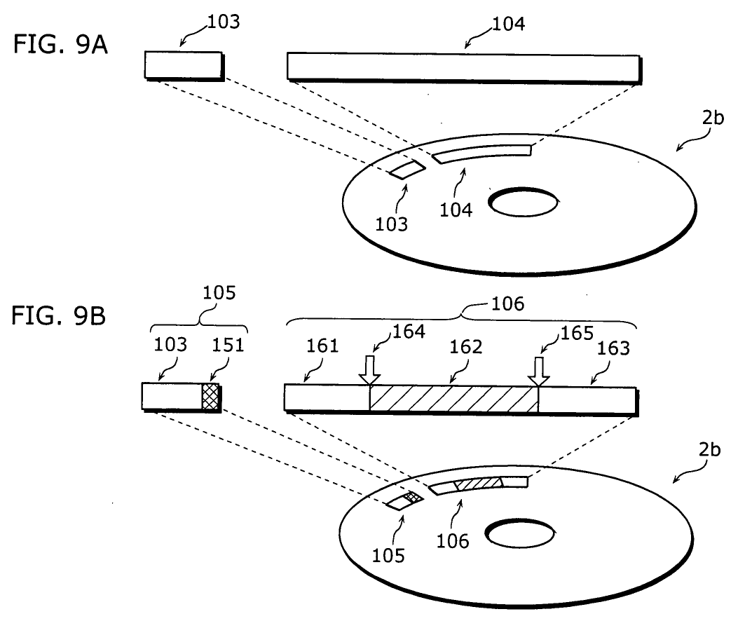

As shown in FIGS. 9A and 9B, for example, the transferred metadata for program management 105 is metadata for program management composed of the pre-transferred metadata 103 for program management to which the destination information according to a diagonally shaded area 162 is attached.

Accordingly, the destination information can be displayed also on a title screen.

Further, the destination information may be inserted into the management data for managing an image signal and an audio signal. In this case, the convenience increases because it can be notified that a part of the content is transferred at the point when it is displayed on a menu before reproducing the content. For example, it is convenient that the part of the content is transferred at the point when the thumbnail pictures are displayed by multiplexing the destination information, as subtitles, to a thumbnail picture of which the contents are displayed as a list and attaches as new thumbnail picture.

It should be noted that the content may be a stream of a MPEG2 transport stream format or as a MPEG2 program stream.

Note that, when the content is transferred from the first recording medium to the second recording medium, conversion processing such as resolution conversion and rate conversion may be performed on the content to be moved or the part of the content, and the details of the converted content may be recorded onto the second recording medium.

For example, when the content is transferred from a BD-RE to a DVD-RAM, the resolution of the content of the MPEG2-TS format recorded on the BD-RE is converted from High Definition Television (HDTV) to Standard Definition Television (SDT), and recorded onto the DVD-RAM after converting into a content of MPEG2-PS format whose data rate is reduced.

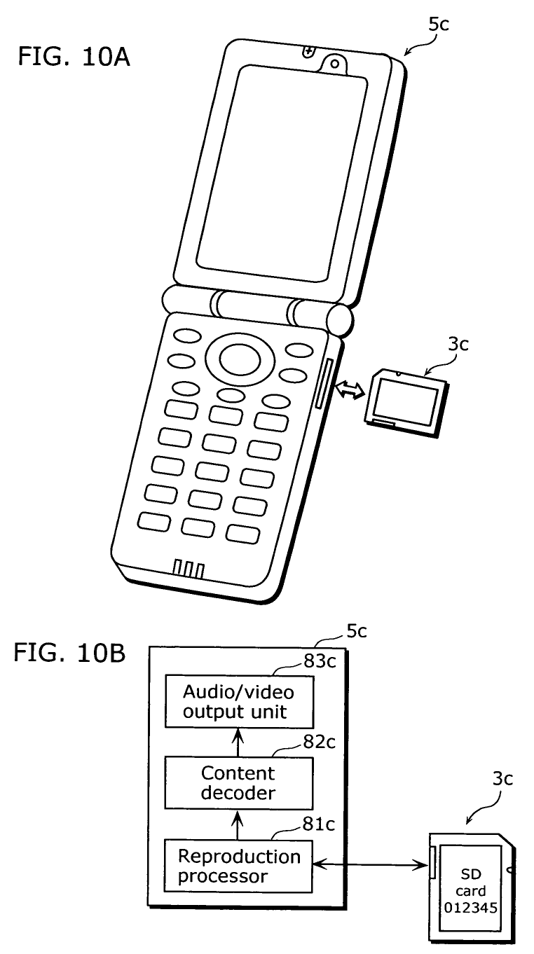

Accordingly, as shown in FIGS. 10A and 10B, for example, the content can be reproduced even by a small lightweight reproduction apparatus 5c, with low electric consumption, having a reproduction processor 81c, a content decoder 82c, and an audio/video output unit 83c.

The reproduction processor 81c reads out the content recorded on a second recording medium 3c, and outputs the read content to the content decoder 83c.

The content decoder 82c decodes the content outputted from the reproduction processor 81c into an audio/video signal, and outputs the decoded audio/video signal to the audio/video output unit 81c.

The audio/video output unit 81c outputs, to a user, the audio/video signal outputted from the content decoder 82c via a portable display device such as a liquid crystal display and a portable headphone.

It should be noted that the recording and reproducing apparatus may have only the first recording and reproducing unit without having the second recording and reproducing unit.

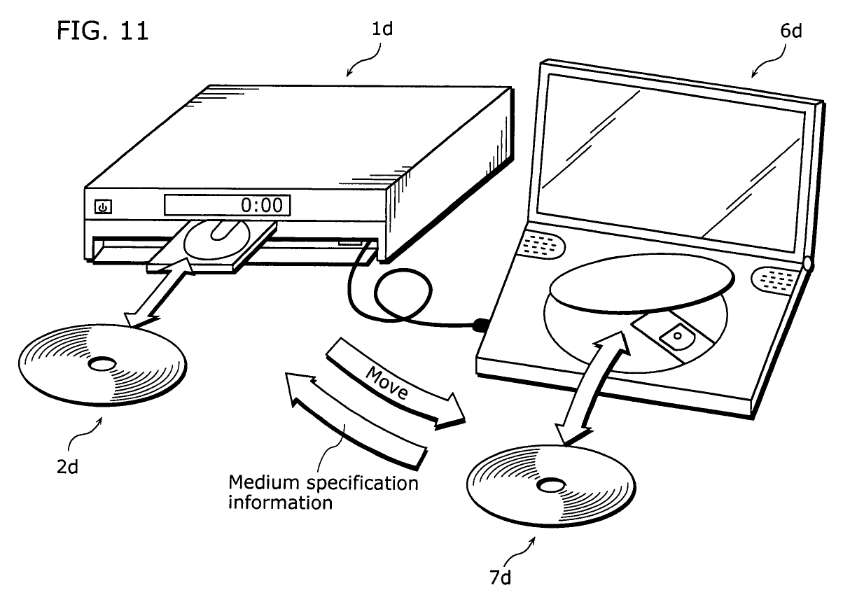

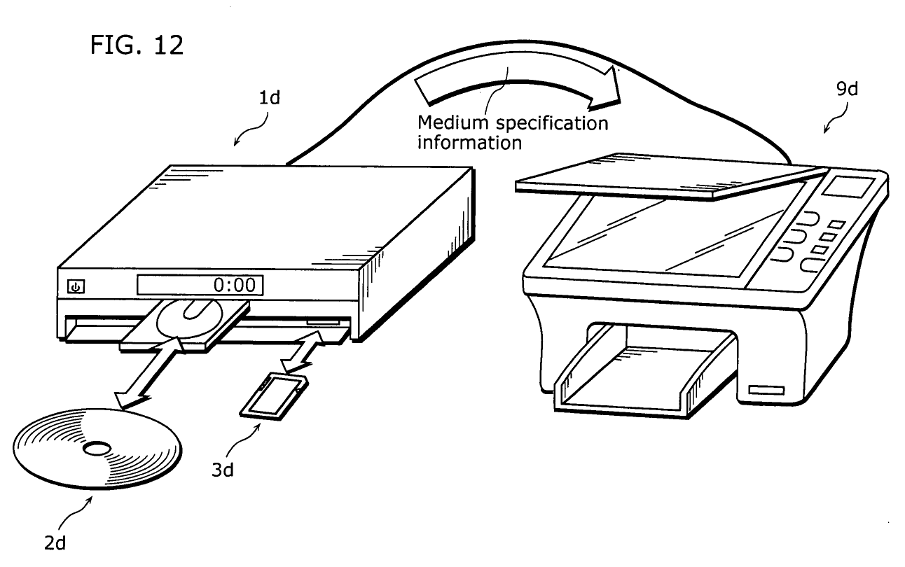

As shown in FIG. 11, for example, the first recording and reproducing unit may be included in the recording and reproducing apparatus 1d and the second recording and reproducing unit may be included in the recording and reproducing apparatus 6d. Herein, the recording and reproducing apparatus 1d obtains medium specification information according to the third recording medium 7d via the portable recording and reproducing apparatus 6d when the content recorded on the first recording medium 2d is transferred to the third recording medium 7d.

It should be noted that the medium specification information may be displayed on a display and the like, or may be outputted to a printer. For example, when it is displayed on a display, the medium specification information can be identified by a user to write the medium specification information displayed on a display on a label of the recording medium. In the case where it is outputted to a printer, it can be identified by a user to attach a label sealing on which the medium specification information is printed on a recording medium.

As shown in FIG. 13, for example, the recording and reproducing apparatus 1d includes the first recording and reproducing unit which reads and writes the first recording medium 2d and the second recording and reproducing unit which reads and writes the second recording medium 3d. When the content recorded on the first recording medium 2d is transferred to the second recording medium 3d, the recording and reproducing apparatus 1d obtains the medium specification information according to the second recording medium 3d via the second recording and reproducing unit, outputs the obtained medium specification information to the printer 9d, and prints it on the label sealing.

It should be noted that destination notification picture may be displayed smoothly from preceding and following contents using a mechanism of bridge clip.

The “bridge clip” is a mechanism for smoothly reproducing junctures of a stream in the BD-RE standard. The details are described in Naozumi Sugimura et al., “Fourth Section<Logical Format>How broadcast programs are stored in a disc,” Next Generation Optical Disc/Deconstruction, Nikkei Business Publications, 2003, pp. 82-83.

It should be noted that when the content is transferred from the first recording medium to the second recording medium, a part of the content to be transferred and has been recorded on the first recording medium may be converted into a reproducible state while duplicating the content to be transferred and a part of the content on the second recording medium.

It should be noted that the recording and reproducing control program may be stored in a computer readable recording medium such as an optical recording medium (e.g. CD-ROM), a magnetic recording medium (e.g. hard disc), an optical magnetic recording medium (e.g. MO), a semiconductor memory (e.g. memory card) and the like so that it can be read out by a hardware system such as a computer system and an embedded system. It then may be executed in other hardware systems through those recording mediums.

Further, it may be executed in other hardware systems which have downloaded the recording and reproducing apparatus control program via a network by holding the recording and reproducing apparatus control program in a hardware system on the network.

It should be noted that the content protection unit may be realized in a recording and reproducing apparatus by a program stored in the ROM or may be embedded in a system Large Scale Integration (LSI).

Here, the system LSI may be realized by a full-custom LSI. Also, it may be realized by a semi-custom LSI such as an Application Specific Integrated Circuit (ASIC). Further, it may be realized by a programmable logic device such as a Field Programmable Gate Array (FPGA) and a Complex Programmable Logic Device (CPLD). Furthermore, it may be realized as a dynamic reconfigurable device whose logic circuit is dynamically rewritable.

Further, configuration data in which one or two or more functions that constitutes the content protection unit are configured in such LSI may be a program (hereafter referred to as HDL program) described in a hardware description language such as a Very high speed integrated circuit Hardware Description Language (VHDL), Verilog-HDL and SystemC. Also, it may be a net list at a gate level obtained by logically synthesizing the HDL program. Further, it may be as macro cell information that is the net list at the gate level to which layout information, program condition and the like are attached. Furthermore, it may be as mask data in which dimension, timing and the like are defined.

The configuration data may be also stored in a computer readable recording medium such as an optical recording medium (e.g. CD-ROM), a magnetic recording medium (e.g. hard disc), an optical magnetic recording medium (e.g. MO), a semiconductor memory (e.g. RAM) and the like so that it can be read by a hardware system such as a computer system and an embedded system. The configuration data read by other hardware system through the recording medium may be downloaded in a programmable logic device via a download cable.

Or, the configuration data may be held in a hardware system on a transmission line as it can be obtained by the other hardware system via a transmission line such as a network. Further, the configuration data obtained by the other hardware system from the hardware system via the transmission line may be downloaded to the programmable logic device via the down load cable.

Or, the configuration data that are logically synthesized, arranged and wired may be recorded in a serial ROM so as to be able to be transmitted to the FPGA when the electric current is applied. The configuration data recorded in the serial ROM may be then downloaded directly in the FPGA when the electric current is applied.

Or, the configuration data that are logically synthesized, distributed and wired may be generated by a microprocessor and downloaded in the FPGA when the electric current is applied.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

This invention as a recording and reproducing apparatus having a copyright protection function can be used, in particular, as a recording and reproducing apparatus that can specify a recording medium of a destination, when all of or a part of copyright-protected digital television broadcast is transferred from a recording medium on which the digital television broadcast has been recorded once to another recording medium.

What is claimed is:

1. A recording and reproducing apparatus comprising:
a destination information generator configured to generate destination information specifying a transfer destination for a part of recorded content; and
a processor configured to associate the transfer destination with a remaining part of the recorded content that was not transferred to the transfer destination.

2. The recording and reproducing apparatus according to claim 1,
wherein the part of recorded content transferred corresponds to a copy of the part of recorded content.

3. The recording and reproducing apparatus according to claim 1,
wherein the destination information generator comprises:
an engine configured to generate the destination information as a graphic or audio signal; and
an encoder configured to encode the graphic or audio signal as an output stream.

4. The recording and reproducing apparatus according to claim 3,
wherein the processor is configured to record the output stream to be reproduced instead of the part of the content transferred.

5. The recording and reproducing apparatus according to claim 1,
wherein the destination information generator further comprises:
a metadata generator configured to generate the destination information as metadata; and
the processor configured to store the metadata as associated with the remaining part.

6. The recording and reproducing apparatus according to claim 5,
wherein the destination information generator further comprises:
an engine configured to generate the destination information read from the meta data as a graphic or audio signal; and
a multiplexer configured to generate an output stream comprising the remaining part and the graphic or audio signal to be reproduced.

7. The recording and reproducing apparatus according to claim 1,
wherein the processor configures the remaining part of the recorded content with an insertion portion into which the destination information is inserted and a content portion which contains the remaining part.

8. The recording and reproducing apparatus according to claim 7,
wherein the insertion portion is a head portion of the remaining part or a part following the remaining part.

9. The recording and reproducing apparatus according to claim 1,
wherein said destination information generator is configured to generate the destination information to be reproduced as one of an audio signal and a video signal.

10. The recording and reproducing apparatus according to claim 1,
wherein the processor is configured to insert the destination information into a bridge clip that connects remaining parts of the remaining content that are adjacent to both sides of the transfer part.

11. The recording and reproducing apparatus according to claim 1,
wherein the processor further comprises a video generator configured to generate the destination information as a part of the content to be displayed.

12. The recording and reproducing apparatus according to claim 1,
wherein the destination information generator is configured to receive information externally specifying a destination recording medium, and generate the destination information based on the received information.

13. The recording and reproducing apparatus according to claim 1,
wherein the destination information generator is configured to obtain information specific to a recording medium from the destination recording medium, and generate the destination information based on the obtained information.

14. The recording and reproducing apparatus according to claim 1,
wherein the destination information generator is configured to generate a random number and assign the random number to a destination recording medium as an identifier.

15. A content protection method comprising:
generating destination information for specifying a destination of a part of content to be transferred; and
transferring the part to a destination corresponding to the destination information;
recording the destination information in a source from which the part was transferred; and
associating the destination information with a remaining part, the remaining part corresponding to a part of the content that was not transferred to the destination.

16. The content protection method according to claim 15, comprising:
generating a graphic or audio signal containing the destination information; and
configuring a data stream comprising the remaining part and the graphic or audio signal to be reproduced instead of the part of the content transferred.

17. The content protection method according to claim 15, comprising:
disabling reproduction of a part of the content corresponding to the part of the content transferred that remains on the source.

18. The content protection method according to claim 15, comprising:
reading destination information from metadata from the source.

19. A content protection program causing a computer system to execute:
generating destination information for specifying a destination of a part of content to be transferred;
transferring the part to a destination corresponding to the destination information;
recording the destination information in a source from which the part was transferred; and
associating the destination information with a remaining part, the remaining part corresponding to a part of the content that was not transferred to the destination.
